(19) United States
(12) Patent Application Publication
(10) Pub. No.: US 2021/0193151 A1
(43) Pub. Date: Jun. 24, 2021

(54) METHOD AND APPARATUS FOR AUTHENTICATING SPEAKER

(71) Applicant: LG ELECTRONICS INC., Seoul (KR)

(72) Inventor: Jungmin SONG, Seoul (KR)

(73) Assignee: LG ELECTRONICS INC., Seoul (KR)

(21) Appl. No.: 16/813,564

(22) Filed: Mar. 9, 2020

(30) Foreign Application Priority Data
Dec. 19, 2019 (KR) 10-2019-0171146

(51) Int. Cl. G10L 17/06; G10L 17/04; G10L 25/21; G10L 25/18; G10L 17/02; G10L 17/00; G10L 25/90; G06N 3/08

(52) U.S. Cl. CPC G10L 17/06; G10L 17/04; G10L 25/21; G06N 3/08; G10L 17/02; G10L 17/005; G10L 25/90; G10L 25/18

(57) ABSTRACT

A speaker voice authentication method and apparatus according to an embodiment of the present disclosure prevent a third party from attempting speaker authentication using a recorded file by distinguishing an actual voice of a speaker from a recorded file obtained by recording the voice of the speaker. Further, at the time of voice authentication, voice recognition artificial intelligence technology is selectively utilized to allow the speaker to perform voice authentication through only one utterance, and receiving of the voice of the speaker may be performed in an Internet of Things (IoT) environment using a 5G network.

### CROSS-REFERENCE TO RELATED APPLICATION

Pursuant to 35 U.S.C. § 119(a), this application claims the benefit of earlier filing date and right of priority to Korean Patent Application No. 10-2019-0171146, filed on Dec. 19, 2019, the contents of which are all hereby incorporated by reference herein in their entirety.

### BACKGROUND

### 1. Technical Field

The present disclosure relates to a method and an apparatus for authenticating a voice based on a voice characteristic of an actual speaker by extracting a difference between a voice of the speaker and a recorded voice obtained by recording the voice of the speaker by one utterance.

### 2. Description of Related Art

The following description is only for the purpose of providing background information related to embodiments of the present disclosure, and the contents to be described do not necessarily constitute related art.

Biometrics refers to technology that identifies and compares body information that cannot be copied by others so as to distinguish a person from others and perform authentication. Among various biometrics technologies, recently, voice recognition technology is actively being studied. Voice recognition technology is mainly classified into “speech recognition” and “speaker authentication”. Speech recognition is to understand the content spoken by unspecified individuals, no matter who the speaker is. In contrast, “speaker authentication” distinguishes “who” is speaking.

As an example of speaker authentication technology, there is a “voice authentication service”. If it is possible to precisely and quickly identify who the speaker is by voice alone, existing methods required for individual authentication in various fields, for example, inconvenient steps of inputting a password after logging-in or authentication via a public certificate can be omitted, thereby providing convenience to the user.

According to speaker authentication technology, after initially registering the voice of a speaker, whenever authentication is requested, authentication is performed depending on whether the voice uttered by the speaker matches the registered voice. When the speaker registers the voice, features are extracted from the voice. The features may be extracted in units of seconds (for example, 10 seconds). The features can be extracted as various types, such as intonation and speech speed, and can distinguish speakers by combining these features.

Meanwhile, the core of speaker authentication technology is security. However, when the registered speaker registers or authenticates his or her voice, if the authentication is performed using one or more utterances, inconvenience occurs in the speaker authentication.

Further, when a third party who is close to the speaker records the voice of the registered speaker without the speaker noticing and attempts speaker authentication using the recorded file, if this cannot be filtered, the speaker may suffer significant damages, and the reliability of the speaker authentication will be lowered.

As described above, for speaker authentication technology, a technology for filtering a recorded file obtained by an unauthorized third party is required.

Korean Patent Registration No. 10-1564087, which embodies the above-mentioned technology, discloses a speaker verification technology which accumulates voice data inputted during a speaker registration process and a speaker verification process, and uses the accumulated voice data so that speaker verification is not affected by variation of the surrounding sound environment.

In the above document, a technology which allows a universal background model GMM model to be gradually adapted to the surrounding sound environment to improve a speaker authentication performance and the accuracy thereof is disclosed. However, there is no disclosure regarding a technology which performs the authentication by one utterance.

Further, in Korean Patent Application Publication No. 10-2019-0077296, a technology which identifies and recognizes a speaker by a speaker authentication procedure, and enables a command of the speaker to be performed without risk of forgery, is disclosed.

In the above-mentioned document, a technology which extracts a speaker feature vector from a voice signal of the speaker, determines whether the speaker is a registered speaker through the extracted speaker feature vector, and transmits a voice recognition result to another device that is communicably connected to the voice recognition apparatus, is disclosed. However, in the above-described document, there is no disclosure regarding a technology for determining voice recognition by one utterance.

In order to overcome the above-described limitation, there is a need for a technology which performs voice authentication by one utterance, while improving security of voice authentication. In particular, authentication technology that uses a voice characteristic of an actual speaker is needed, rather than a method of authenticating the voice by extracting the modification of the voice generated at the time of recording or a characteristic of a background sound of the uttered voice.

The background art described above may be technical information retained by the present inventors in order to derive the present disclosure or acquired by the present inventors along the process of deriving the present disclosure, and thus is not necessarily a known art disclosed to the general public before the filing of the present application.

### SUMMARY OF THE INVENTION

Embodiments of the present disclosure are directed to distinguishing an actual voice of the speaker and a recorded file obtained by recording the voice of the speaker, so as to prevent a third party from attempting speaker authentication using the recorded file.

Embodiments of the present disclosure are further directed to enabling voice authentication by one utterance of the speaker, so as to improve convenience of voice authentication.

Aspects of the present disclosure are not limited to the above-mentioned aspects, and other aspects and advantages of the present disclosure, which are not mentioned, will be understood through the following description, and will become apparent from the embodiments of the present disclosure. It is also to be understood that the aspects of the present disclosure may be realized by means and combinations thereof set forth in claims.

A method and an apparatus for authenticating a voice of a speaker utilizing voice recognition artificial intelligence technology according to the present disclosure may include a plurality of processors for authenticating the voice of the speaker and a memory connected to the processors.

Authenticating the voice of a speaker may be realized through a process of registering a voice of a speaker for use as an authentication criterion, receiving a voice to be verified, determining whether the registered voice of the speaker and the received voice to be verified are the same person's voice, and in response to a determination that the registered voice of the speaker and the received voice to be verified are the same person's voice, determining whether the voice to be verified is forged.

In this case, when determining whether the voice of the voice to be verified is forged, in response to a degree of similarity between a voice fingerprint of the speaker extracted from voice data of the speaker and a voice fingerprint of the voice to be verified extracted from data of the voice to be verified being equal to or higher than a threshold value, it may be determined that the voice to be verified is a forged voice, by a similarity determining neural network.

Other aspects and features than those described above will become apparent from the following drawings, claims, and detailed description of the present disclosure.

According to the method and the apparatus for authenticating a voice of a speaker according to embodiments of the present disclosure, an actual voice of the speaker and a recorded file obtained by recording the voice of the speaker can be distinguished, and a third party can thus be prevented from attempting speaker authentication using the recorded file.

Specifically, a voice uttered by the speaker to operate an electronic device may generate spectral peaks having different distributions each time an utterance is made. However, when a third party reproduces a voice file obtained by recording the voice uttered by the speaker toward the electronic device, a spectral peak may be generated from the recorded voice file, and the generated spectral peak generated from the recorded voice file may match or be similar to any one of the previously generated spectral peaks. Therefore, a voice fingerprint element of the recorded voice file extracted from the recorded voice file may have a value that is partially similar to and/or the same as any one previously extracted voice fingerprint element.

Therefore, when a degree of similarity between a new voice fingerprint element extracted from a voice to be verified and the speaker voice fingerprint element is equal to or higher than a predetermined threshold value, it may be determined that the voice to be verified is a recorded file or a forged file.

Further, when it is determined that the voice to be verified is a recorded file or a forged file, the operation of the electronic device is not performed. Accordingly, a third party can be prevented from using the electronic device, thereby improving security of the electronic device.

Moreover, the speaker makes the utterance only once. In this case, it can be determined that the uttered voice of the user is a forged voice by matching the uttered voice of the user to previously stored information. Therefore, since voice authentication is possible by only one utterance, the convenience of voice authentication can be improved.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of an environment for speaker authentication according to an embodiment of the present disclosure;

FIG. 2 is a view for explaining a voice artificial intelligence technology for speaker authentication according to an embodiment of the present disclosure;

FIG. 3 is a view for explaining a configuration of an electronic device for speaker authentication according to an embodiment of the present disclosure;

FIG. 4 is a view exemplarily illustrating a feature of a spectral energy distribution extracted from voice data of a speaker according to an embodiment of the present disclosure;

FIG. 5 is a view illustrating determination of a degree of similarity between a voice fingerprint extracted from voice data of a speaker and a voice fingerprint extracted from the uttered voice of the speaker according to an embodiment of the present disclosure;

FIG. 6 is a flowchart for explaining a speaker verification process according to an embodiment of the present disclosure;

FIG. 7 is a flowchart for a speaker voice authentication method according to an embodiment of the present disclosure;

FIG. 8A is a view illustrating a voice frequency extracted from voice data of a speaker according to an embodiment of the present disclosure;

FIG. 8B is a view illustrating a spectral energy distribution extracted by analyzing the voice frequency of FIG. 8A;

FIG. 8C is a view illustrating a plurality of spectral peaks having an energy higher than an average energy of the spectral energy distribution of FIG. 8B;

FIG. 9A is a view illustrating a spectral energy distribution to which noise extracted from voice data of a speaker according to an embodiment of the present disclosure is not added;

FIG. 9B is a view illustrating an example in which noise of 10 dB is added to the spectral energy distribution of FIG. 9A to which noise is not added;

FIG. 9C is a view illustrating an example in which noise of 5 dB is added to the spectral energy distribution of FIG. 9A to which noise is not added; and

FIG. 10 is a view exemplarily illustrating a feature of a spectral energy distribution extracted from each utterance when the same speaker makes an utterance multiple times, according to the embodiment of the present disclosure.

### DETAILED DESCRIPTION

Hereinafter the embodiments disclosed in this specification will be described in detail with reference to the accompanying drawings. The present disclosure may be embodied in various different forms and is not limited to the embodiments set forth herein. Hereinafter in order to clearly describe the present disclosure, parts that are not directly related to the description are omitted. However, in implementing an apparatus or a system to which the spirit of the present disclosure is applied, it is not meant that such an omitted configuration is unnecessary. Further, like reference numerals refer to like elements throughout the specification.

In the following description, although the terms “first”, “second”, and the like may be used herein to describe various elements, these elements should not be limited by these terms. These terms may be only used to distinguish one element from another element. Also, in the following description, the articles “a,” “an,” and “the,” include plural referents unless the context clearly dictates otherwise.

In the following description, it will be understood that terms such as “comprise,” “include,” “have,” and the like are intended to specify the presence of stated feature, integer, step, operation, component, part or combination thereof, but do not preclude the presence or addition of one or more other features, integers, steps, operations, components, parts or combinations thereof.

Hereinafter, the present disclosure will be described in detail with reference to the drawings.

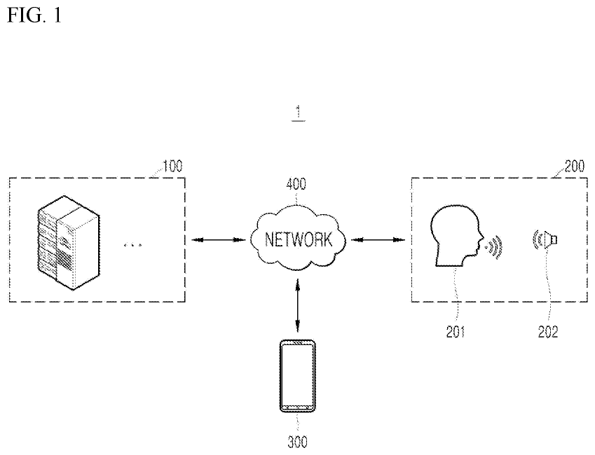

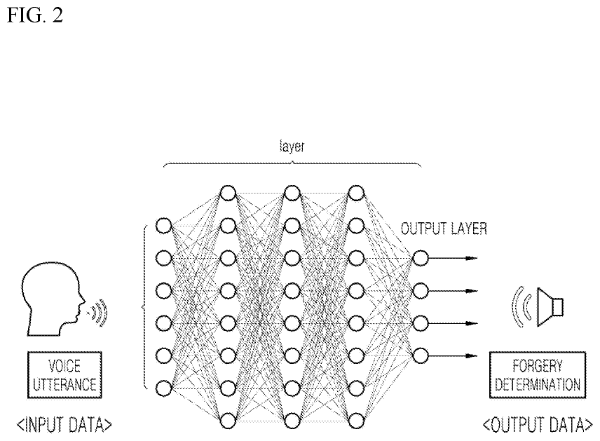

FIG. 1 is an exemplary diagram of an environment for speaker authentication according to an embodiment of the present disclosure, and FIG. 2 is a view for explaining a voice artificial intelligence technology for speaker authentication according to an embodiment of the present disclosure.

Referring to the drawings, an environment 1 for speaker authentication according to an embodiment of the present disclosure includes a speaker 201 who is capable of uttering speech, a voice to be verified 202 for forgery verification based on the voice of the speaker 201, an electronic device 300 which receives the voice of the speaker 201 and the voice to be verified 202, and a network 400 which allows communication between the server 100 and the above-mentioned components.

The speaker 201 refers to a person who is capable of uttering speech toward the electronic device 300 to control the operation of the electronic device 300, such as “Hi, LG”, or “Play music”.

In this case, the speech uttered by the speaker 201 may be classified into an instruction to perform an operation of the electronic device 300 and an authentication word which is stored in the electronic device 300 in order to authenticate the instruction uttered by the speaker 201 to determine whether the electronic device 300 can be operated by the instruction.

Specifically, the authentication word is a voice uttered by a user (a speaker in the embodiment of the present disclosure) who wants to use a speaker authentication service for the operation of the electronic device 300. That is, the authentication word may be a voice of a user who operates the electronic device 300 when the electronic device 300 is first operated, or a voice of a user for operating the electronic device 300 later. The voice of the user may be stored in a database 305 of the electronic device 300.

The authentication word is a voice file of a speaker who has applied and been approved for the speaker authentication service for security when using the electronic device 300. Subsequently, upon receiving a request for speaker authentication, the authentication word may be used as a control group for the requesting voice (the voice to be verified according to the embodiment of the present disclosure), to be used as a criterion for determining whether a requesting voice is a forged voice.

Further, the electronic device 300 which is capable of receiving the voice of the speaker 201 and the voice to be verified 202 may support object-to-object intelligent communication such as Internet of things (IoT), Internet of everything (IoE), internet of small things (IoST), and may also support machine to machine (M2M) communication and device to device (D2D) communication.

The electronic device 300 may determine an image converting method using big data, an artificial intelligence (AI) algorithm and/or a machine learning algorithm in the 5G environment connected for Internet of Things.

The electronic device 300 may receive voice data uttered by the speaker 201 and the voice to be verified 202 through a microphone installed in the electronic device 300. Since the speaker authentication needs to be performed based on the voice data of the speaker 201, the electronic device 300 includes a voice input/output interface, and also includes an embedded system as the Internet of things. Examples of the electronic device 300 may be a terminal (for example, a portable phone or a tablet PC) which serves as an AI assistant.

When the voice of the speaker 201 is registered in the electronic device 300, the voice of the voice to be verified 202 for forgery verification may be received. Subsequently, the electronic device 300 determines whether the voice of the speaker 201 and the received voice to be verified 202 are the same person's voice, and in response to a determination that the voice of the speaker 201 and the voice to be verified 202 are the same person's voice, a process of determining whether the voice to be verified 202 is a forged voice may be performed.

Specifically, a degree of similarity between a voice fingerprint of the speaker 201 extracted from voice data of the speaker 201 and a voice fingerprint of a voice to be verified extracted from voice data of the voice to be verified 202 is determined using a similarity determining neural network. In this case, in response to the degree of similarity between the speaker voice fingerprint and the voice fingerprint of the voice to be verified 202 being equal to or higher than a predetermined threshold value, it is determined that the voice to be verified 202 is a forged voice.

The technology for determining a forged voice file as described above may be performed by artificial intelligence. Artificial intelligence technology may be generated via a training step by a training system (not illustrated) which is applied to the electronic device 300.

A learning model generated by the training system is a voice recognition neural network that may be trained in advance to extract voice data of the speaker 201, which is stored in the electronic device 300 or received by the electronic device 300, as a voice frequency.

Generally, the learning model may finish the training step in a separate server or a training system (not illustrated), and may then be stored in the electronic device 300 in advance to extract the voice data of the speaker 201 as a voice frequency. However, in some embodiments, the learning model may be implemented to be updated or upgraded in the electronic device 300 through additional training.

The electronic device 300 may transmit and receive data to and from the server 100 through a 5G network. In particular, the electronic device 300 may perform data communication with the server 100 via the 5G network by using at least one service of enhanced mobile broadband (eMBB), ultra-reliable and low latency communications (URLLC), or massive machine-type communications (mMTC).

eMBB is a mobile broadband service, and provides, for example, multimedia contents and wireless data access. In addition, improved mobile services such as hotspots and broadband coverage for accommodating the rapidly growing mobile traffic may be provided via eMBB. Through a hotspot, high-volume traffic may be accommodated in an area where utterer mobility is low and user density is high. A wide and stable wireless environment and utterer mobility can be secured by wideband coverage.

URLLC defines requirements that are far more stringent than existing LTE in terms of reliability and transmission delay of data transmission and reception, and corresponds to a 5G service for production process automation in fields such as industrial fields, telemedicine, remote surgery, transportation, safety, and the like.

mMTC (massive machine-type communications) is a transmission delay-insensitive service that requires a relatively small amount of data transmission. mMTC enables a much larger number of terminals, such as sensors, than general mobile cellular phones to be simultaneously connected to a wireless access network. In this case, the price of the communication module of a terminal should be low, and a technology improved to increase power efficiency and save power is required to enable operation for several years without replacing or recharging a battery.

As described above, the electronic device 300 according to the embodiment of the present disclosure may store the voice of the speaker 201, and store or include a deep neural network to which artificial intelligence technology for determining whether a voice fingerprint extracted from the voice data uttered by the voice to be verified 202 is a forged voice is applied, or various learning models such as different types of machine learning models or technology including the same.

Artificial intelligence (AI) is an area of computer engineering science and information technology that studies methods to make computers mimic intelligent human behaviors such as reasoning, learning, self-improving, and the like, or how to make computers mimic such intelligent human behaviors.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

Specifically, machine learning is a technology that investigates and constructs systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

An ANN is a data processing system modeled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

Specifically, ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the ANN may include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a previous layer.

ANNs may include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. The input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer may be a representative artificial neural network which enables deep learning, which is one machine learning technique.

An ANN can be trained using training data. Here, the training may refer to the process of determining parameters of the artificial neural network by using the training data, to perform tasks such as classification, regression analysis, and clustering of inputted data. Representative examples of parameters of the artificial neural network may include synaptic weights and biases applied to neurons.

An ANN trained using training data can classify or cluster inputted data according to a pattern within the inputted data.

Throughout the present specification, an ANN trained using training data may be referred to as a trained model.

Hereinbelow, learning paradigms of an artificial neural network will be described in detail.

The learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning may include clustering and independent component analysis.

Examples of artificial neural networks using unsupervised learning may include a generative adversarial network (GAN) and an autoencoder (AE).

GAN is a machine learning method in which two different artificial intelligences, a generator and a discriminator, improve performance through competing with each other.

The generator may be a model creating new data that generate new data based on true data.

The discriminator may be a model recognizing patterns in data that determines whether inputted data is from the true data or from the new data generated by the generator.

Furthermore, the generator may receive and learn data that has failed to fool the discriminator, while the discriminator may receive and learn data that has succeeded in fooling the discriminator. Accordingly, the generator may evolve so as to fool the discriminator as effectively as possible, while the discriminator may evolve so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. In this case, since the number of nodes in the output layer is greater than the number of nodes in the hidden layer, the dimensionality of the data increases, thus data decompression or decoding may be performed.

Furthermore, in the AE, the inputted data may be represented as hidden layer data as interneuron connection strengths are adjusted through learning. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent may find an optimal path based on experience without reference to data.

Reinforcement learning may be performed primarily by a Markov decision process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

The hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. The one-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be used to minimize a cost function, and examples of such learning optimization algorithms may include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size. In the SGD, the momentum and NAG may also include methods that increase optimization accuracy by adjusting the step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network may include not only the structure and learning optimization algorithms of the artificial neural network but also the hyperparameters thereof. Therefore, in order to obtain a good learning model, it is important to choose a proper structure and learning algorithms for the artificial neural network, but also to choose proper hyperparameters.

In general, the hyperparameters may be set to various values experimentally to learn artificial neural networks, and may be set to optimal values that provide stable learning rate and accuracy of the learning result.

The network 400 may be a wired and wireless network, for example, a local area network (LAN), a wide area network (WAN), the Internet, an intranet, and an extranet, and any suitable communication network including a mobile network, for example, cellular, 3G, 4G, LTE, 5G, and Wi-Fi networks, an ad hoc network, and a combination thereof

The network 400 may include connection of network elements such as hubs, bridges, routers, switches, and gateways. The network 400 may include one or more connected networks, including a public network such as the Internet and a private network such as a secure corporate private network. For example, the network may include a multi-network environment. Access to the network 400 can be provided via one or more wired or wireless access networks.

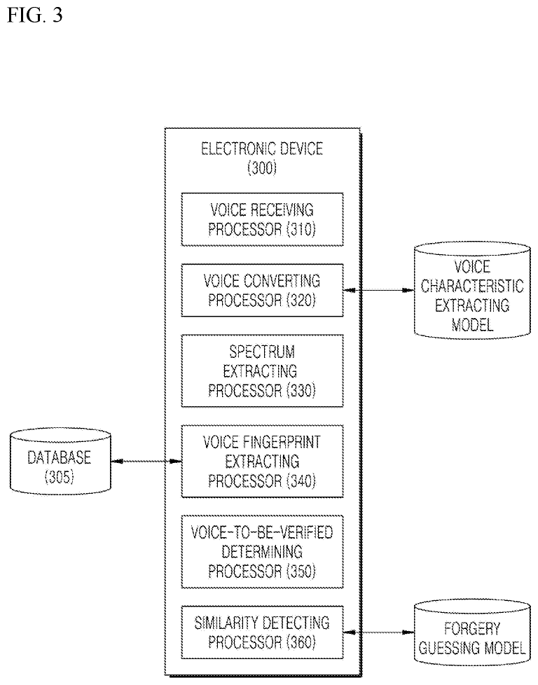

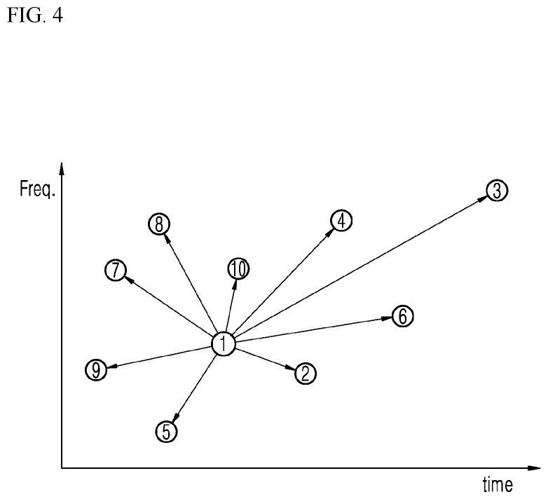

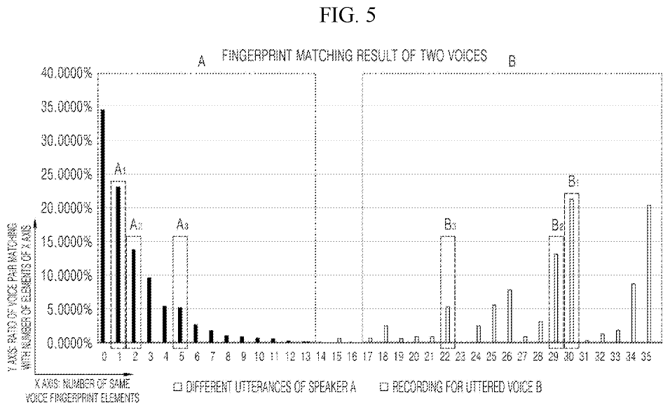

FIG. 3 is a view for explaining a configuration of an electronic device for speaker authentication according to an embodiment of the present disclosure, FIG. 4 is a view exemplarily illustrating a feature of a spectral energy distribution extracted from voice data of a speaker according to an embodiment of the present disclosure, and FIG. 5 is a view illustrating determination of a degree of similarity between a voice fingerprint extracted from voice data of a speaker and a voice fingerprint extracted from the uttered voice of the speaker according to an embodiment of the present disclosure.

A series of processes from registering a voice uttered by the speaker in the electronic device 300 to determining whether a voice to be verified 202 is a forged voice may be performed by a plurality of processors. Here, the processors which configure the electronic device 300 may be configured as one server, or each of the processors may be configured as one or more servers.

Further, the electronic device 300 may include a processor which registers the voice of the speaker 201 as reference data, and processors which compare the voice to be verified 202 and the registered voice of the speaker 201 to determine whether the voice to be verified 202 is forged.

Specifically, referring to the drawings, the electronic device 300 includes a voice receiving processor 310 which receives the voice of the speaker 201.

The voice receiving processor 310 is configured to receive the uttered voice of the speaker 201 through a microphone included in the electronic device 300. The data collected by the speaker voice receiving processor 310 may be voices uttered by the speaker 201, and the voice uttered by the speaker 201 may be a voice which controls an operation of the electronic device 300, such as “Hi, LG”, or “Play music”.

Here, the voice uttered by the speaker may be classified into an instruction to control an operation of the electronic device 300 and an authentication word which is stored in the electronic device 300 to authenticate the instruction uttered by the speaker 201 to determine whether the electronic device 300 can be operated by the instruction.

For example, when the electronic device 300 is first used, “Hi, LG” may be inputted to turn on/off the electronic device 300. In this case, “Hi, LG” uttered by the speaker 201 may be the authentication word, and when the speaker 201 utters “Hi, LG” to operate the electronic device 300 after storing the authentication word, the uttered “Hi, LG” may be an instruction.

Upon the voice receiving processor 310 receiving the voice of the speaker 201, the collected voice of the speaker 201 may be converted by a voice converting processor 320.

Specifically, when the electronic device 300 receives voice data of the speaker 201, the voice data may be extracted as a voice frequency. A voice frequency refers to a frequency in the frequency range of the human voice. Similarly, the voice frequency may be referred to as a frequency of 200 Hz to 3500 Hz, which is the frequency range required to convey, for example, a conversation.

After converting the collected voice of the speaker 201 by the voice converting processor 320, a spectral energy distribution is extracted and analyzed from the voice frequency extracted by the voice converting processor 320, by a spectrum extracting processor 330.

The spectral energy distribution refers to a distribution of energy of the voice frequency, and specifically refers to a spectral energy distribution found for every unit time.

Even when the same speaker utters the same word or sentence, different frequency bands may be extracted each time the speaker utters the word or sentence, due to an environment at the time of utterance and a voice condition of the speaker. Therefore, each time the same speaker utters the same word or sentence, the spectral energy distribution may have a different magnitude.

This characteristic allows the spectrum extracting processor 330 to extract the spectral energy distribution from the voice frequency generated each time the speaker 201 makes an utterance.

Further, the spectrum extracting processor 330 may extract a plurality of spectral peaks having a higher energy than an average energy of the extracted spectral energy distribution.

The spectral peak refers to a tendency of the speaker 201 to place stress on specific words and specific vowels or consonants. For example, when the speaker utters “Hi, LG”, the “L” may be strongly enunciated or have a higher pitch. In this case, the frequency of the “L” utterance may be measured to be high, and as the frequency is higher, the energy of the spectral energy distribution extracted from the voice data when “L” is uttered is higher.

As such, since a spectral peak having a higher energy than the average energy of the spectral energy distribution has a high energy, the spectral peak is strong to noise and the energy thereof is not changed even when the voice is recorded.

The spectral peak extracted as described above is used as data from which a voice fingerprint of the speaker can be extracted through a voice fingerprint extracting processor 340.

Specifically, the voice fingerprint of the speaker is data from which it can be determined whether the voice to be verified 202 is a forged voice.

Specifically, even when the same speaker utters the same sentence or word at different times, the spectral energy distribution may be different each time the utterance is made. That is, distributions of a plurality of spectral peaks having an energy which is higher than an average energy generated when the same sentence or word is uttered at different times may be different. Therefore, a voice fingerprint of the speaker having different characteristics may be extracted each time the utterance is made, due to the difference in spectral peak generated at each utterance. The voice fingerprint of the speaker extracted as described above may be stored in a database 305. In response to a degree of similarity between the voice fingerprint stored in the database 305 and a voice fingerprint of the voice to be verified extracted from the voice to be verified 202 being equal to or higher than a threshold value, it may be determined that the voice of the voice to be verified 202 is a forged voice.

Specifically, the voice fingerprint includes a plurality of voice fingerprint elements. The voice fingerprint elements may be obtained by extracting 9 to 11 spectral peaks whose energy is sequentially reduced from a spectral peak having the maximum energy, and comparing a time difference between each spectral peak.

For example, in the case of the voice fingerprint of the speaker, a spectral peak having the maximum energy is referred to as a first spectral peak (see FIG. 4 (1)) and spectral peaks having a second energy and a third energy may be referred to as a second spectral peak (see FIG. 4 (2) and a third spectral peak (see FIG. 4 (3)).

After extracting the plurality of spectral peaks (see FIGS. 4 (1) to (10)), the time difference between the first spectral peak and the second spectral peak is measured to extract a first voice fingerprint element. Similarly, a time difference between the first spectral peak and the third spectral peak is measured to extract a second voice fingerprint element.

The voice fingerprint elements extracted as described above allows estimation of which syllable is stressed and in which frequency domain energies higher than an average energy of the spectral energy distribution are generated when the speaker 201 makes an utterance.

In the embodiment of the present disclosure, after extracting 10 spectral peaks having energies higher than an average energy of the spectral energy distribution, a time difference between the first spectral peak having the maximum energy and the remaining 9 spectral peaks is measured, and a time difference between a second spectral peak having a second maximum energy and the remaining 8 spectral peaks is measured, to extract a total of 35 voice fingerprint elements.

After extracting the voice fingerprint elements as described above, the voice fingerprint of the voice to be verified is extracted using the plurality of processes described above, upon receiving voice data of the voice to be verified 202.

As described above, even when the same sentence or word is uttered at different times, the spectral energy distribution may be different each time the utterance is made, and thus voice fingerprints having different characteristics may be extracted each time the utterance is made. Therefore, different distributions of spectral peaks having an energy higher than an average energy of the spectral energy distribution may be generated each time the utterance is made.

That is, new voice fingerprint elements extracted from new voice data uttered by the speaker 201 are matched to voice fingerprint elements stored in the database 305.

Specifically, as illustrated in FIG. 5, assuming that a stored voice fingerprint element (in the embodiment of the present disclosure, the voice of the speaker) is A and an uttered and extracted voice fingerprint element is B (in the embodiment of the present disclosure, the voice to be verified), fingerprint element A and fingerprint element B are matched to each other. In this case, it is determined that ratios of A₁, A₂, and A₃ and B₁, B₂, and B₃ are similar. Here, assuming that a newly uttered voice is determined to be a forged voice if there are three or more similar ratios, it may be determined that the fingerprint element B is a forgery of the voice from which the fingerprint element A was extracted.

As described above, in response to the degree of similarity between the voice fingerprint element of the voice to be verified and the stored speaker voice fingerprint element being equal to or higher than the threshold value, the voice data of the voice to be verified 202 may be determined as one among previously uttered voices from which voice fingerprint elements of the speaker have already been extracted. Accordingly, the voice to be verified 202 may be determined as a recorded forged voice, and the operation of the electronic device 300 may not be performed.

In this case, the speaker makes only one utterance. That is, it can be determined whether the uttered voice of the speaker is a forged voice by matching the uttered voice of the speaker to information stored in the database 305.

Here, regarding the threshold value for determining the forged voice, the voice the voice fingerprint elements of the voice to be verified extracted from the voice data and the voice fingerprint elements stored in the database 305 may be compared, and in response to the ratios thereof that are the same being equal to or higher than a predetermined ratio, the voice to be verified can be determined as a forged voice.

Meanwhile, upon the voice receiving processor 310 receiving the voice to be verified 202, it is necessary to determine whether the voice to be verified 202 is the voice of the same person as the speaker 201 whose voice is registered in the electronic device 300.

To this end, a voice characteristic of the speaker 201 is extracted from the voice data of the speaker 201 by a voice-to-be-verified determining processor 350. Similarly, the voice characteristic of the voice to be verified 202 is extracted from the voice data of the voice to be verified 202. Thereafter, in response to the degree of similarity between the voice characteristic of the speaker 201 and the voice characteristic of the voice to be verified 202 being equal to or higher than a previously stored threshold value, it may be determined that the voice to be verified 202 is the voice of the same person as the speaker 201.

In this case, with respect to the voice characteristic of the speaker 201 and the voice characteristic of the voice to be verified 202, at least any one of statistical characteristics of an utterance speed, an utterance pitch, or a voice frequency domain extracted from the voice data of the speaker 201 and the voice to be verified 202 may act as a condition.

That is, when the voice to be verified 202 and the voice of speaker 201 are the same person's voice, an average sound pitch, an average uttering speed, and an average voice frequency domain of the voice to be verified 202 may be substantially the same as those of the voice of the speaker 201.

In this case, in response to the degree of similarity between the voice fingerprint of the speaker and the voice fingerprint of the voice to be verified being determined to be equal to or lower than a predetermined threshold value by a similarity detecting processor 360 using data learned in a forgery guessing model, the determination of the forgery of the voice to be verified 202 may be stopped.

For example, when a voice uttered by a person other than the speaker 201 or a recorded voice obtained by recording a voice uttered by another person is reproduced, a voice fingerprint extracted from the voice of the other person and the voice fingerprint of the speaker are different. For example, when similarity threshold value of the voice fingerprint of the speaker and the voice fingerprint of the voice to be verified is three or more, it may be determined that the voice to be verified is a voice forging the speaker's voice. In this case, when there is no similarity between the voice fingerprint of the speaker and the voice fingerprint of the voice to be verified, the voice to be verified is determined to be the voice of a different person from the speaker, and the determining of voice forgery and the operation of the electronic device 300 may be stopped.

In contrast, when the degree of similarity between the voice characteristic of the speaker and the voice characteristic of the voice to be verified is equal to or higher than the threshold value, the voice to be verified 202 may be determined to be the voice of the same person as the speaker 201.

Through these characteristics, when the degree of similarity is equal to or lower than the threshold value and the voice characteristics are determined to be similar, it can be estimated that the voice to be verified 202 is the voice of the same person as the speaker 201, and that the utterances were made at different times.

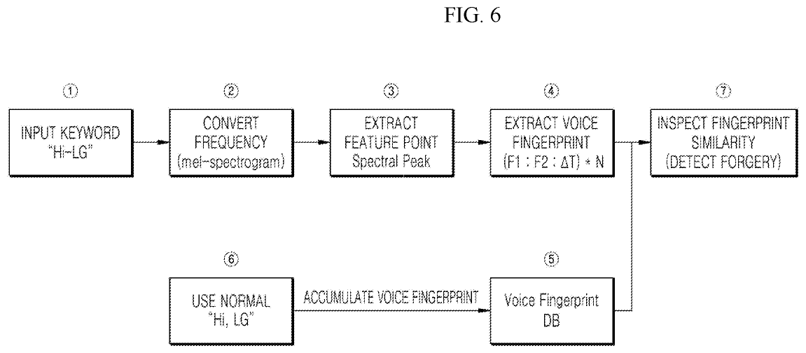

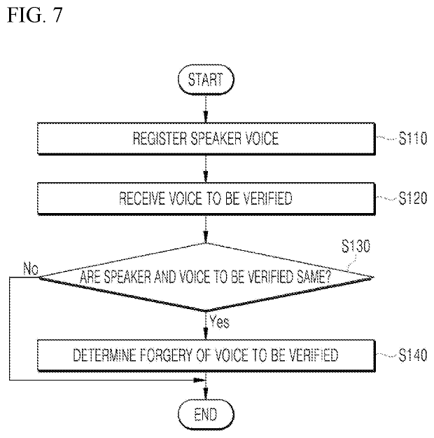

FIG. 6 is a flowchart for explaining a speaker verification process according to an embodiment of the present disclosure, and FIG. 7 is a flowchart for a speaker voice authentication method according to an embodiment of the present disclosure.

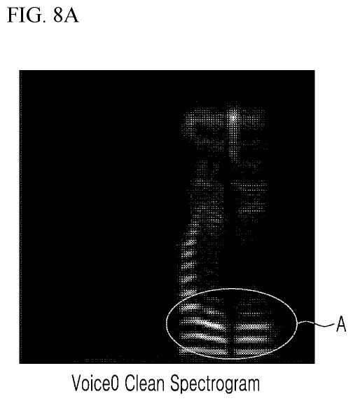

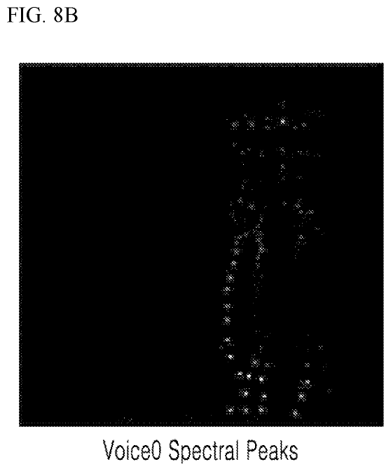

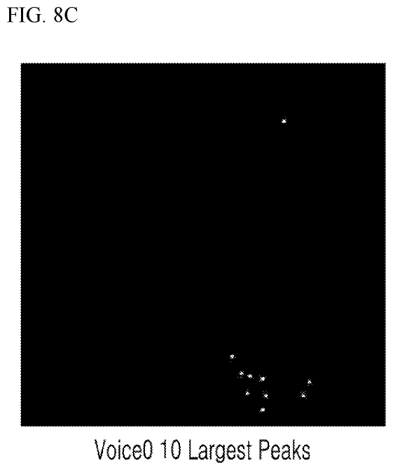

FIG. 8A is a view illustrating a voice frequency extracted from voice data of a speaker according to an embodiment of the present disclosure, FIG. 8B is a view illustrating spectral energy distribution extracted by analyzing the voice frequency of FIG. 8A, and FIG. 8C is a view illustrating a plurality of spectral peaks having energy higher than an average energy of the spectral energy distribution of FIG. 8B.

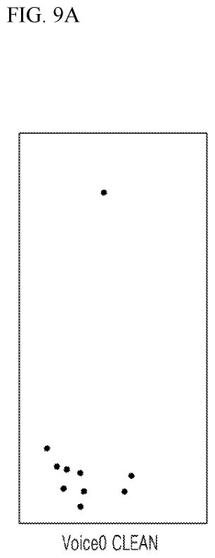

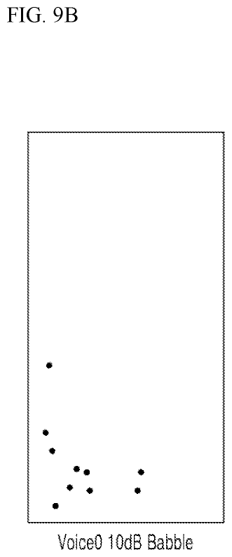

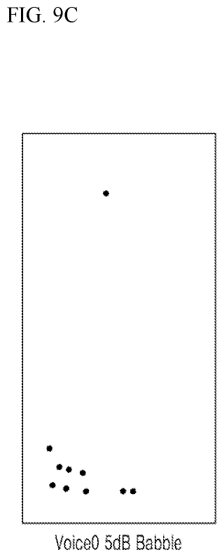

Further, FIG. 9A is a view illustrating a spectral energy distribution to which noise extracted from voice data of a speaker according to an embodiment of the present disclosure is not added, FIG. 9B is a view illustrating an example in which noise of 10 dB is added to the spectral energy distribution of FIG. 9A to which noise is not added, and FIG. 9C is a view illustrating an example in which noise of 5 dB is added to the spectral energy distribution of FIG. 9A to which noise is not added.

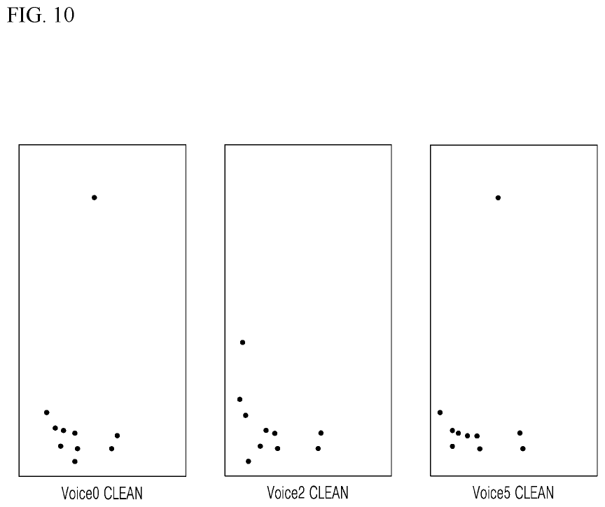

Further, FIG. 10 is a view exemplarily illustrating a characteristic of a spectral energy distribution extracted from each utterance when the same speaker makes an utterance multiple times, according to the embodiment of the present disclosure.

Referring to the drawings, the speaker 201 may utter a keyword which can be inputted to the electronic device 300 ((1) of FIG. 6). For example, the speaker 201 may utter “Hi, LG”, and voice data extracted from the uttered voice may be registered for use as speaker authentication data for security of the electronic device 300 (S110).

When the speaker 201 makes an utterance, a voice frequency may be extracted from the uttered voice (S121), and a spectral energy distribution from the extracted voice frequency may be analyzed ((2) and (3) of FIG. 6).

The voice frequency refers to a frequency in the frequency range of the human voice, and when the speaker makes an utterance, a frequency distribution with respect to time may be generated as illustrated in FIG. 8A. In this case, it can be confirmed that a frequency band having a large signal magnitude is distributed in a brighter and wider area than the surrounding area, as illustrated in area A of FIG. 8A.

A spectral energy distribution extracted by analyzing the voice frequency refers to a spectral energy distribution of a voice frequency found at every unit time, as illustrated in FIG. 8B. Generally, the spectral energy distribution may have a similar distribution to the frequency distribution.

A plurality of spectral peaks having an energy higher than an average energy of the extracted spectral energy distribution may be extracted. That is, referring to FIGS. 8B and 8C, a plurality of spectral energy distributions may be extracted from the entire spectral energy distribution, referred to as spectral peaks.

Specifically, the extracted spectral peak refers to a frequency band having the highest energy in the entire spectral energy distribution, and voice data of the frequency band having a high energy may have a constant energy magnitude regardless of a change in the surrounding environment. Therefore, even when noise is added to the extracted spectral peak, the position (the energy magnitude) of the spectral peak may not change. With this characteristic, the frequency at which the speaker primarily utters at the time of making the utterance can be ascertained.

That is, even when noise of 10 dB or noise of 5 dB is added to a spectral energy distribution to which noise extracted from voice data generated by the utterance of the speaker 201 is not added (see FIG. 9A) and a spectral energy distribution to which noise is not added, the position of the spectral peak does not change (see FIGS. 9B and 9C).

That is, since in a spectral peak having a high energy, the energy is not reduced by the noise, a frequency characterized by the utterance of the speaker 201 may be estimated.

In contrast, when the same speaker 201 utters the same sentence or word at different times, different voice data may be generated each time the utterance is made, and thus spectral peaks having energy with different magnitude may be extracted each time the utterance is made.

That is, as illustrated in FIG. 10, when the same speaker makes an utterance at different times, an utterance pitch, an utterance rate, and stress may vary depending on the environment where the speaker 201 makes the utterance and a voice condition of the speaker 201. Therefore, as illustrated in FIG. 10, spectral peaks having different energies may be extracted at each time.

Based on the above-described characteristic, the spectral peak extracted from the utterance of the speaker 201 and the spectral peaks stored in the database are compared so as to determine whether the uttered voice of the speaker 201 is a recorded file (a forged voice).

To this end, a voice fingerprint is extracted using a spectral peak extracted from the spectral energy distribution ((4) of FIG. 6).

The voice fingerprint includes a plurality of voice fingerprint elements. The voice fingerprint elements may be obtained by extracting 9 to 11 spectral peaks whose energy is sequentially reduced from a spectral peak having the maximum energy, and comparing a time difference between each spectral peak.

For example, after extracting a first spectral peak (the spectral peak having the maximum energy) to a tenth spectral peak ((1) to (10) of FIG. 4), time differences between the first spectral peak and the second to the tenth spectral peak and time differences between the second spectral peak and the third to tenth spectral peaks are sequentially extracted.

The voice fingerprint elements extracted as described above may be stored in the database 305 ((5) of FIG. 6). When the speaker 201 makes an utterance, the extracted voice fingerprint elements may be utilized as data to estimate which syllable is stressed and a domain of the frequency where energies higher than an average energy of the spectral energy distribution are generated.

As described above, after extracting the voice fingerprint elements, data of a voice to be verified is received, and it is determined whether the received voice to be verified is the voice of the same speaker (S120 and S130).

Specifically, a voice characteristic of the speaker 201 is extracted from the voice data of the speaker 201. Similarly, a voice characteristic of the voice to be verified 202 is extracted from the voice data of the voice to be verified 202. Thereafter, in response to the degree of similarity between the voice characteristic of the speaker 201 and the voice characteristic of the voice to be verified 202 being equal to or higher than a previously stored threshold value, it may be determined that the voice to be verified 202 is the voice of the same person as the speaker 201.

In this case, with respect to the voice characteristic of the speaker 201 and the voice characteristic of the voice to be verified 202, at least any one of statistical characteristics of an utterance rate, an utterance pitch, or a voice frequency domain extracted from the voice data of the speaker 201 and the voice to be verified 202 may act as a condition.

Upon a determination that the voice to be verified is the voice of the same speaker as described above, a voice fingerprint of the voice to be verified for data of the voice to be verified is extracted using a plurality of processes.

A degree of similarity may be measured by matching a voice fingerprint element of the voice to be verified extracted as described above to the voice fingerprint element previously extracted from the voice data of the speaker 201 ((6) and (7) of FIG. 6).

That is, even when the same sentence or word is uttered at different times, the spectral energy distribution may be different each time the utterance is made, and thus voice fingerprints having different characteristics may be extracted each time the utterance is made. Therefore, different distributions of the spectral peaks having energy higher than an average energy of the spectral energy distribution may be generated each time the utterance is made.

For example, when the speaker 201 operates the electronic device 300, the speaker utters “Hi, LG”, and a spectral peak having a different distribution may be generated each time the utterance is made. The spectral peaks generated as described above may be stored in the database 305.

Meanwhile, when a third party reproduces a voice file obtained by recording “Hi, LG” uttered by the speaker 201 toward the electronic device 300, a spectral peak is generated from the recorded voice file. The spectral peak generated from the recorded voice file matches or is similar to any one of spectral peaks stored in the database 305. Therefore, a voice fingerprint element of the recorded voice file extracted from the recorded voice file may have a value that is partially similar to and/or the same as any one voice fingerprint element stored in the database 305.

Therefore, in response to a degree of similarity between a voice fingerprint element of a voice to be verified extracted from a voice to be verified and the speaker voice fingerprint element being equal to or higher than a predetermined threshold value, it may be determined that the voice to be verified is a recorded file or a forged file based thereon (S140).

In this case, the speaker makes only one utterance. By matching the utterance of the speaker made only once to information stored in the database 305, it can be determined whether the uttered voice of the speaker is a forged voice. Therefore, voice authentication is possible by one utterance, and the convenience of the voice authentication can thereby be improved.

As described above, an actual voice of the speaker and a recorded file obtained by recording the voice of the speaker can be distinguished, and a third party can thus be prevented from attempting speaker authentication using the recorded file.

That is, when the speaker operates an electronic device, an uttered voice may generate a spectral peak having a different distribution each time the utterance is made. When a third party reproduces a voice file obtained by recording the voice uttered by the speaker toward the electronic device, a spectral peak may be generated from the recorded voice file. In this case, the spectral peak generated from the recorded voice file may match or be similar to any one of the previously generated spectral peaks. Therefore, a voice fingerprint element of the recorded voice file extracted from the recorded voice file may have a value that is partially similar to and/or the same as any one voice fingerprint element which is extracted in advance.

Therefore, in response to the degree of similarity between a new voice fingerprint element extracted from a voice to be verified and the speaker voice fingerprint element being equal to or higher than a predetermined threshold value, it may be determined that the voice to be verified is a recorded file or a forged file.

Further, when it is determined that the voice to be verified is a recorded file or a forged file, the operation of the electronic device is not performed. Accordingly, a third party can be prevented from using the electronic device, thereby improving security of the electronic device.

Moreover, the speaker makes the utterance only once. As such, it can be determined that the uttered voice of the speaker is a forged voice by matching the uttered voice of the speaker to previously stored information. Therefore, since voice authentication is possible by only one utterance, the convenience of voice authentication can be improved.

The example embodiments described above may be implemented through computer programs executable through various components on a computer, and such computer programs may be recorded in computer-readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

The computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. Also, the steps included in the methods according to the present disclosure may be performed through the processor or modules for performing the functions of the step. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations can be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A speaker voice authentication method utilizing voice recognition artificial intelligence technology, the method comprising:
registering a voice of a speaker for use as an authentication criterion;
receiving a voice to be verified;
determining whether the registered voice of the speaker and the received voice to be verified are the same person's voice; and
in response to a determination that the registered voice of the speaker and the received voice to be verified are the same person's voice, determining whether the voice to be verified is forged,
wherein the determining whether the voice to be verified is forged comprises:
determining that the voice to be verified is a forged voice in response to a degree of similarity between a voice fingerprint of the speaker extracted from voice data of the speaker and a voice fingerprint of the voice to be verified extracted from data of the voice to be verified being equal to or higher than a threshold value, by a similarity determining neural network.

2. The speaker voice authentication method according to claim 1, wherein the registering of a voice of a speaker comprises:
extracting voice data of the speaker as a voice frequency;
analyzing a spectral energy distribution extracted from the voice frequency;
extracting a plurality of spectral peaks having energy higher than an average energy from the analyzed energy distribution; and
extracting a voice fingerprint of the speaker based on the extracted spectral peak.

3. The speaker voice authentication method according to claim 2,
wherein the extracting of a voice fingerprint of the speaker comprises extracting a plurality of voice fingerprint elements from the voice fingerprint of the speaker, and
wherein the extracting of a plurality of voice fingerprint elements comprises measuring a time difference between a first spectral peak having a maximum energy among the plurality of spectral peaks and each of the spectral peaks having energies lower than the energy of the first spectral peak.

4. The speaker voice authentication method according to claim 1, wherein the determining whether the voice to be verified is forged comprises:
extracting data of the voice to be verified as a voice frequency;
analyzing a spectral energy distribution extracted from the voice frequency;
extracting a plurality of spectral peaks having energy higher than an average energy from the analyzed energy distribution; and
extracting a voice fingerprint of the voice to be verified based on the extracted spectral peak.

5. The speaker voice authentication method according to claim 4,
wherein the extracting of a fingerprint of the voice to be verified comprises extracting a plurality of voice fingerprint elements from the fingerprint of the voice to be verified, and
wherein the extracting of a plurality of voice fingerprint elements comprises measuring a time difference between a first spectral peak having a maximum energy among the plurality of spectral peaks and each of the spectral peaks having energies lower than the energy of the first spectral peak.

6. The speaker voice authentication method according to claim 1, wherein the determining whether the registered voice of the speaker and the received voice to be verified are the same person's voice comprises:
extracting a voice characteristic of the speaker from the voice data of the speaker;
extracting a voice characteristic of the voice to be verified from the data of the voice to be verified; and
determining that the speaker and a speaker of the voice to be verified are the same person in response to a degree of similarity between the voice characteristic of the speaker and the voice characteristic of the voice to be verified being equal to or higher than a previously stored threshold value.

7. The speaker voice authentication method according to claim 6, wherein the extracting of the voice characteristic of the speaker comprises extracting at least any one of statistical characteristics of an utterance speed of the speaker, an utterance pitch of the speaker, or a voice frequency domain extracted from the voice data of the speaker.

8. The speaker voice authentication method according to claim 6, wherein the extracting of the voice characteristic of the voice to be verified comprises extracting at least any one of statistical characteristics of an utterance speed of the voice to be verified, an utterance pitch of the voice to be verified, or a voice frequency domain extracted from the data of the voice to be verified.

9. The speaker voice authentication method according to claim 6, wherein the determining that the speaker and a speaker of the voice to be verified are the same person comprises stopping determining whether the voice to be verified is forged in response to a degree of similarity between the speaker voice fingerprint and the voice fingerprint of the voice to be verified being equal to or lower than a predetermined threshold value.

10. A speaker voice authentication apparatus utilizing voice recognition artificial intelligence technology, the apparatus comprising:
processors; and
a memory connected to the processors,
wherein the memory stores instructions configured to, when executed by the processors, cause the processors to:
receive a voice to be verified for voice authentication;
determine whether a registered voice of the speaker and the received voice to be verified are the same person's voice; and
in response to a determination that the voice of the speaker and the received voice to be verified are the same person's voice, in order to determine whether the voice to be verified is forged, determine that the voice to be verified is a forged voice in response to a degree of similarity between a voice fingerprint of the speaker extracted from voice data of the speaker and a voice fingerprint of the voice to be verified extracted from voice data of the voice to be verified being equal to or higher than a threshold value, through a similarity determining neural network.

11. The speaker voice authentication apparatus according to claim 10, wherein the memory stores instructions configured to cause the processors to:
extract voice data of the speaker as a voice frequency;
analyze a spectral energy distribution extracted from the voice frequency;
extract a plurality of spectral peaks having energy higher than an average energy from the analyzed energy distribution; and
extract a voice fingerprint of the speaker based on the extracted spectral peak.

12. The speaker voice authentication apparatus according to claim 11, wherein the memory stores instructions configured to cause the processors to measure a time difference between a first spectral peak having a maximum energy among the plurality of spectral peaks and each of the spectral peaks having energies lower than the energy of the first spectral peak in order to extract a plurality of voice fingerprint elements from the voice fingerprint of the speaker.

13. The speaker voice authentication apparatus according to claim 10, wherein the memory stores instructions configured to cause the processors to:
extract voice data of the voice to be verified as a voice frequency;
analyze a spectral energy distribution extracted from the voice frequency;
extract a plurality of spectral peaks having energy higher than an average energy from the analyzed energy distribution; and
extract a voice fingerprint of the voice to be verified based on the extracted spectral peak.

14. The speaker voice authentication apparatus according to claim 13, wherein the memory stores instructions configured to cause the processors to:
extract a plurality of voice fingerprint elements of the voice to be verified from the voice fingerprint of the voice to be verified; and
upon extraction of the plurality of voice fingerprint elements of the voice to be verified, measure a time difference between a first spectral peak having a maximum energy among the plurality of spectral peaks and each of the spectral peaks having energies lower than the energy of the first spectral peak.

15. The speaker voice authentication apparatus according to claim 10, wherein the memory stores instructions configured to cause the processors to:
extract a voice characteristic of the speaker from the voice data of the speaker; and
upon extraction of a voice characteristic of the voice to be verified from the voice data of the voice to be verified, determine that the speaker and a speaker of the voice to be verified are the same person in response to a degree of similarity between the voice characteristic of the speaker and the voice characteristic of the voice to be verified being equal to or higher than a previously stored threshold value.

16. The speaker voice authentication apparatus according to claim 15, wherein the memory stores instructions configured to cause the processors to extract at least any one of statistical characteristics of an utterance speed of the speaker, an utterance pitch of the speaker, or a voice frequency domain extracted from the voice data of the speaker.

17. The speaker voice authentication apparatus according to claim 15, wherein the memory stores instructions configured to cause the processors to extract at least any one of statistical characteristics of an utterance speed of the voice to be verified, an utterance pitch of the voice to be verified, or a voice frequency domain extracted from the data of the voice to be verified.

18. The speaker voice authentication apparatus according to claim 15, wherein the memory stores instructions configured to cause the processors to determine that the voice to be verified is an utterance made by the same speaker at a different time in response to a degree of similarity between the voice fingerprint of the speaker and the voice fingerprint of the voice to be verified being equal to or lower than a threshold value and a degree of similarity between the voice characteristic of the speaker and the voice characteristic of the voice to be verified being equal to or higher than a previously stored threshold value.
